(19) United States
(12) Patent Application Publication
(10) Pub. No.: US 2021/0172800 A1
(43) Pub. Date: Jun. 10, 2021

(54) Systems and Methods for Analyzing Unknown Sample Compositions Using a Prediction Model Based On Optical Emission Spectra

(71) Applicant: PerkinElmer Health Sciences Canada, Inc., Woodbridge (CA)

(72) Inventors: Abdul Al-Haimi, Waterloo (CA); James McQuay, Waterloo (CA); Hamid Badiei, Woodbridge (CA)

(21) Appl. No.: 16/709,199

(22) Filed: Dec. 10, 2019

(51) Int. Cl. G01J 3/443

(52) U.S. Cl. CPC G01J 3/443; G01J 2003/2833

(57) ABSTRACT

Aspects of the disclosure relate to techniques for analyzing unknown sample compositions using a prediction model based on optical emission spectra. One method comprises: receiving first emission spectra corresponding to a training sample comprising a plurality of pure elements of known concentrations; determining, based on the first emission spectra, a plurality of spectral regions corresponding to the plurality of pure elements of known concentrations; determining, for each spectral region corresponding to each pure element of a known concentration, features associated with a signature peak of the spectral region; training a prediction model to predict unknown concentrations of a plurality of constituents of an unknown sample based on an emission spectra of the unknown sample; receiving second emission spectra corresponding to the unknown sample comprising a plurality of constituents of unknown concentrations; and generating, based on the application of the trained prediction model, a concentration for each of the constituents of the unknown sample.

### TECHNICAL FIELD

The disclosures herein relate generally to spectroscopy systems and methods. More particularly, in some examples, the disclosure relates to systems and methods for analyzing unknown sample compositions through optical emission spectroscopy.

### BACKGROUND

Optical emission spectroscopy (OES) is an imaging and analytical technique used to determine the constituents (e.g., elemental composition) of a broad range of samples. In particular, OES techniques excite a sample and measure the light that, as a result of the excitement, is emitted by the sample. The emitted light is spatially dispersed such that the different wavelengths of the emitted light may be measured, resulting in a measured spectrum. A spectrum that is measured during OES typically comprises multiple sets of atomic emission lines that can be used to determine the constituent elements and/or compounds of the sample. The atomic emission lines are a result of energy released by electrons of the constituent elements as they move from higher to lower electron energy levels of a particular atom. Each atomic element has a unique set of atomic emission lines. Thus, the optical emission spectrum measured during OES may be used to qualitatively identify the constituents of a sample based on a predicted pattern of energy released by the electrons of each constituent element or compound.

In addition to including multiple constituent elements and/or compounds, each constituent of a sample may have a wide range of concentrations. During OES, the amount of light emitted by a particular element (e.g., the amount of light associated with a particular set of atomic emission lines) correlates with the concentration of that particular element within the sample. Thus, the optical emission spectrum obtained during OES can be used to quantitatively determine the concentration of each constituent element within the sample.

### SUMMARY

Aspects of the disclosure relate to techniques for analyzing unknown sample compositions using a prediction model based on optical emission spectra.

The disclosure provides, for example, a method for estimating an unknown sample composition. The sample composition may include desired analytes along with interfering elements or compounds that may cause spectral interference. Through the use of a prediction model, the method allows for a more accurate estimation of the sample composition (e.g., identities and concentrations of the constituent elements or compounds).

In at least one method, a first emission spectra may be received from a storage, an external computing system, or from one or more detectors of a spectroscopy system. The first emission spectra may correspond to a training sample comprising a plurality of pure elements of known concentrations. One or more processors of a computing system may determine, based on the first emission spectra corresponding to the training sample, a plurality of spectral regions corresponding to the plurality of pure elements of known concentration. The computing system may further determine, for each spectral region corresponding to each pure element of a known concentration, one or more features associated with a signature peak of the spectral region. Thereafter, the computing system may form, for each spectral region corresponding to each pure element of the known concentration, a feature vector comprising the one or more features associated with the signature peak of the spectral region. The computing system may associate the feature vector with the known concentration of the pure element corresponding to the spectral region. Also or alternatively, the computing system may form matrices comprising, for each spectral region, a value based on the feature vector and the known concentration of the pure element corresponding to the spectral region. The computing system may train, based on the associated feature vectors or the matrices, a prediction model to predict unknown concentrations of a plurality of constituents of an unknown sample. A second emission spectra may be received, from one or more detectors of a spectroscopy system. The second emission spectra may correspond to an unknown sample comprising a plurality of constituents of unknown concentrations. The computing system may generate, based on the application of the trained prediction model, a concentration for each of the constituents of the unknown sample.

In certain examples, generating the concentration for each of the constituents of the unknown sample may comprise determining, based on the second emission spectra, a plurality of spectral regions corresponding to the plurality of the constituents of the unknown concentrations. The computing system may determine, for each spectral region corresponding to each of the plurality of constituents of the unknown concentration, one or more features associated with a signature peak of the spectral region corresponding to the constituent of the unknown concentration. The computing system may form, for each spectral region corresponding to each of the plurality of the constituents of the unknown concentration, a feature vector comprising of the one or more features associated with the signature peak of the spectral region corresponding to the constituent of the unknown concentration. Furthermore, for each spectral region corresponding to each of the plurality of the constituents of the unknown concentration, the computing system may apply the feature vector into the trained machine learning algorithm.

The emission filter has a field of view over which it is illuminated by the emission spectrum. The locations of the emission filter's field of view may be characterized using, e.g., (x, y) position coordinates. For each position within the field of view, the emission spectrum may illuminate the emission filter at a respective angle of incidence. The angle of incidence may influence the measured intensity of the transmission spectrum from the emission filter at that position.

The disclosures below also provide a system that may include, for example one or more emission filters of an imaging modality that provides emission spectra; and a computing device storing instructions for analyzing unknown sample compositions through spectroscopy using a prediction model. When executed by one or more processors of the computing device, the instructions may cause the computing device to: receive, from the one or more emission filters, first emission spectra corresponding to a training sample comprising a plurality of pure elements of known concentrations; determine, based on the first emission spectra corresponding to the training sample, a plurality of spectral regions corresponding to the plurality of pure elements of known concentration; determine, for each spectral region corresponding to each pure element of a known concentration, one or more features associated with a signature peak of the spectral region; form, for each spectral region corresponding to each pure element of the known concentration, a feature vector comprising the one or more features associated with the signature peak of the spectral region; associate, for each spectral region corresponding to each pure element of the known concentration, the feature vector with the known concentration of the pure element corresponding to the spectral region; train, based on the associated feature vectors, a prediction model to predict unknown concentrations of a plurality of constituents of an unknown sample; receive, from the emission filter, second emission spectra corresponding to the unknown sample comprising a plurality of constituents of unknown concentrations; and generate, based on the application of the trained prediction model, a concentration for each of the constituents of the unknown sample.

In some aspects, the imaging modality may be one or more of an inductively coupled plasma optical emission spectrometry (ICP-OES), infrared spectroscopy, nuclear magnetic resonance (NMR) spectroscopy, or an ultraviolet (UV) spectroscopy.

It should be appreciated that aspects of the various examples described herein may be combined with and/or substituted for aspects of other examples (e.g., elements of claims depending from one independent claim may be used to further specify implementations of other independent claims). Other features and advantages of the disclosure will be apparent from the following figures, detailed description, and the claims.

The objects and features of the disclosure can be better understood with reference to the drawings described below, and the claims. In the drawings, like numerals are used to indicate like parts throughout the various views.

### BRIEF DESCRIPTION OF DRAWINGS

FIG. 1 is a diagram of an example of an optical emission spectroscopy system.

FIG. 2 is a block diagram of example computing hardware on which aspects of the disclosures herein may be implemented.

FIG. 3 depicts an example method for analyzing unknown sample compositions using a prediction model based on optical emission spectra.

FIGS. 4A-4D depict example training and testing matrices for generating and applying a prediction model used in various aspects of the present disclosure.

### DETAILED DESCRIPTION

The inventors have recognized and appreciated that determining the constituents (e.g., elements, compounds, etc.) of a chemical sample by OES is often challenging due to spectral interference, which may result when atomic emission lines from a first element (sometimes referred to as an interfering constituent) within the sample overlap with an atomic emission line of interest from a second element (sometimes referred to as the desired analyte). Spectral interference can be a result of the spectral richness of atomic emission line spectra. Interfering constituents of a sample can form unwanted lines that overlap (directly or partially) with a desired analyte's atomic emission lines in an OES spectrum. Thus, spectral interference may complicate both qualitative and quantitative determinations of the constituents of a sample.

Conventional techniques of interference correction involve knowing, a priori, various properties or characteristics (e.g., an identity, a sample composition, etc.) of the unknown sample being analyzed. For example, one conventional technique first determines the composition of the interfering constituent of the unknown sample before performing the OES analysis for a desired analyte. Another conventional technique of spectral interference correction uses reference spectra for blank samples and samples having several standard concentrations of known elements. The inventors have recognized and appreciated that these conventional techniques of spectral interference correction are labor-intensive, time-inefficient and error prone, because various steps of these techniques must be repeated multiple times for each unknown sample being analyzed. Accordingly, the inventors have developed techniques that correct for spectral interference that are simpler and less prone to error than these conventional techniques.

Various implementations of the present disclosure address one or more of the challenges described above. For example, the present disclosure may describe systems, methods, devices, and apparatuses for analyzing unknown sample compositions using a prediction model based on optical emission spectra.

Described herein are techniques for analyzing unknown sample compositions through OES using a prediction model based on optical emission spectra. In some embodiments, the use of the prediction model overcomes the need to determine the compositions of interfering constituents of the sample to correct for spectral interference resulting from the interfering constituents. Removing the need for determining the compositions of interfering constituents reduces the number of steps necessary thereby saving time, cost and reducing the chance for error. For example, in at least one embodiment, a user of the above-described systems, methods, apparatuses, and devices may only input a “blank” sample and an unknown sample, as will be described below, without the need to know the identities and/or compositions of the interfering constituents in advance or perform additional analyses to determine the identities and/or compositions of the interfering constituents. In various embodiments of the present disclosure, the expected emission spectra of pure elements may be sufficient to allow one to determine what constituent elements and/or compounds make up a sample and with what concentrations. These embodiments disclosed herein may allow the users to overcome the laborious and time intensive steps in conventional techniques of interference correction.

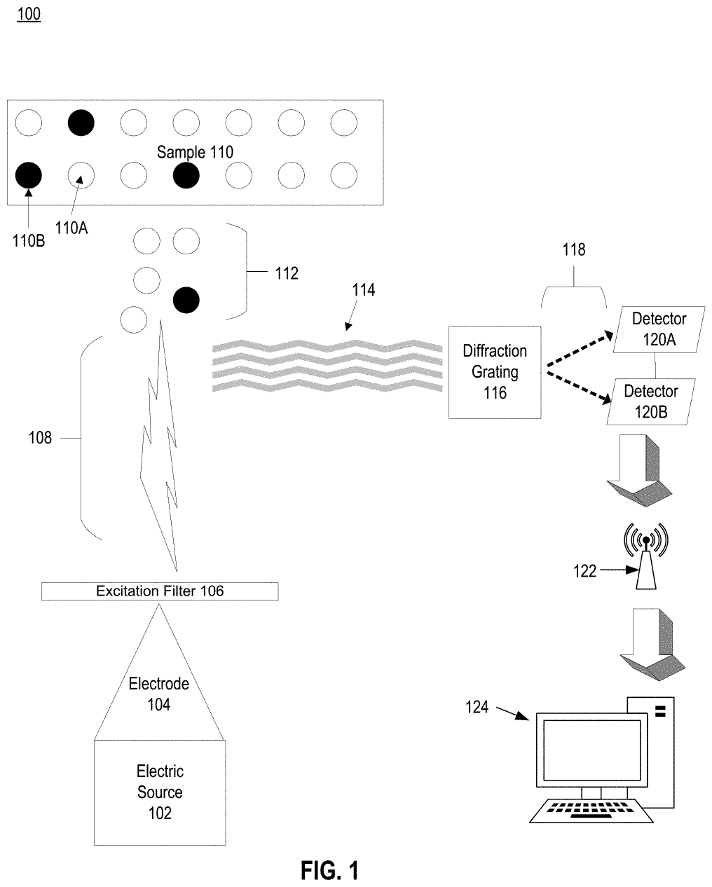

FIG. 1 is a diagram of an example of an OES system. The components of the example OES system 100 are described below by way of example in the context of an OES technique in which excitation energy is used to excite the atoms of constituent elements or compounds of a sample in which emission light from the sample is analyzed to determine the composition of the sample. It should be appreciated, however, that other types of spectroscopy systems may include additional and alternative components and/or techniques. For example, other types of spectroscopy systems may include various forms of atomic emission spectroscopy, flame emission spectroscopy, inductively coupled plasma atomic emission spectroscopy, spark and arc emission spectroscopy, etc. Components of the example optical imaging system 100 are presented in the order that the excitation energy originates and is absorbed by the sample, and as the sample emits light, which passes through to the detectors, in a typical operation, i.e., along a path of energy. As shown in FIG. 1. an OES system 100 may include, at a high level, an electric source 102, a sample 110, a diffraction grating device 116, one or more detectors (e.g., 120A, 120B, etc.), and a computing system 124.

The electric source 102 may be any device that receives electricity (e.g., via a power outlet) and uses the electricity to discharge and/or direct energy toward the sample 110. For example, as shown in FIG. 1, the electric source 102 may be an electrical device that uses an electrode 104 to discharge an electric spark or arc to the sample 110. The electric source 102 may be used to excite electrons of the atoms of constituent elements and compounds within sample 110. The discharge 108 may be thermal energy (e.g., if the excitation source is a flame), and/or electrical energy. Furthermore, the discharge 108 may be visible (e.g., spark, light, laser etc.) or invisible (e.g., ultraviolet, infrared, heat etc.) to the human eye.

In the example OES system 100 shown in FIG. 1, the discharge 108 from the electric source 102 may be generated using an electrode 104. For example, the electric source 102 may apply a high voltage to the electrode 104 so that it becomes a high voltage source. The difference in electric potential between the sample 110 and the electrode 104 may thus be used to produce the discharge 108, which in this case is an electrical discharge.

In the example OES system 100 in FIG. 1, the excitation filter 106 may be a device that filters, concentrates, and/or otherwise adjusts the discharge 108 as it travels from the electric source 102 toward the sample 110. For example, the excitation filter 106 may be used to increase, decrease, or set a specific range of the intensity of the discharge 108 that is directed to the sample. In some implementations, e.g., where the excitation source directs light to the sample, the excitation filter 106 may be used to select a wavelength or wavelength range of light that would reach the sample 110. The OES system 100 may provide multiple excitation filters to choose from. The user may select which excitation filter to use or the excitation filter may be automatically selected by the computing system 124, or some other controller, that controls the operation of the OES system 100. In some implementations additional devices (e.g., switches, fiber bundles, etc.) may assist in diverting the discharge 108 as it exits the excitation filter 106 towards various points of the sample 110, e.g., via fiber optic cable.

As the discharge 108 strikes the sample 110, the discharge 108 may excite, heat, vaporize, and/or otherwise energize at least some of the sample 110, e.g., constituent elements and compounds at the surface of the sample that comes in contact with the discharged energy. For example, a discharged spark, arc, or flame may cause a small part of the sample to turn into plasma 112, e.g., as shown in FIG. 1. In some implementations, a part of the sample 110 could be heated up to thousands of degrees Celsius.

The electrons of the constituents of the plasma 112 may get excited as a result of the energy transferred from the electric source 102 via the discharge 108. As may be known to those having ordinary skill in the art, electrons may be typically situated around an atom in orbits of varying energy levels. An excitement of an electron may cause the electron to move to an orbit corresponding to a higher energy level. The movement of the electron to the orbit corresponding to the higher energy level may leave a vacancy in the orbit corresponding to the former (lower) energy level. This vacancy may cause the atom to become unstable. To stabilize the atom, an electron that is different from or the same as the electron that moved to the higher energy level may move back to the former (lower) energy level having the vacancy. As electrons move from an orbit corresponding to a higher energy level to an orbit corresponding to a lower energy level, energy may be released. The energy release may be in the form of a light or optical emission. Given that each constituent element or compound (e.g., constituent 110A and constituent 110B) may be defined or characterized by a unique atomic structure with unique electron orbits corresponding to electron energy levels, energy released as a result of the above-described process may produce optical emissions of a fixed wavelength or energy of radiation. For example, since differences between two or more energy levels of atomic orbits for a constituent element or compound may already be known, each transition (e.g., an electron moving down from a higher energy level to a lower energy level) may produce a specific optical emission line of a fixed wavelength or energy of radiation.

As the amounts of energy released through this process are discrete and dependent on the electron orbits that are characteristic of an element or compound, a user may be able to identify an element or compound based on the specific pattern of the amounts of energy released (e.g., an optical emission spectrum). For example, some elements, which typically have electrons at orbits corresponding to very high energy levels, may release very high energy of a specific amount as a result of electrons moving down energy levels. Furthermore, some constituent elements or compounds (e.g., metallic elements) emit optical emissions of many wavelengths after interacting with the discharge 108, thus resulting in an optical emission spectrum of many emission lines. This may be because of a plurality of electron transitions between various combinations of energy levels in the atomic structure of the metallic element, thus emitting energy radiation of many wavelengths. Thus, the specific pattern of energy that is released may be a result of predictable movement of electrons between the atomic orbits that a constituent element or compound is known to have.

The light released by the constituent element or compound through the above-described process may be referred to as “emitted light,” “optical emission” “emission spectrum” or “atomic emission.” The emitted light may be of discrete wavelengths and may therefore form distinct optical emission lines depending on the element or compound releasing it.

It is expected that a sample 110 may comprise a variety of constituent elements or compounds (e.g., constituents 110A and 110B). Furthermore, it is expected that an atom of an element or compound may have a plurality of atomic orbits for its electrons, each atomic orbit corresponding to a different energy level. For example, atoms of constituent 110A may have a set of atomic orbits that are distinct from those of the atoms of constituent 110B. This variety may lead to a plurality of amounts of energy to be released by the constituent elements or compounds, which may form emitted energy (e.g., light) of multiple wavelengths, which may be directed to flow through a diffraction grating device 116. For simplicity the emitted energy (e.g., light) of multiple waveforms, which stem from the sample, and are directed to the diffraction grating device 116, can be referred to as “multiple emission lines” 114. As shown in FIG. 1, the multiple emission lines 114 may be directed to pass through a diffraction grating device 116. For example, optical emission released from the sample 110 may be directed into the diffraction grating device 116 through the use of reflective surfaces, fiber bundles, etc.

The diffraction grating device 116 may separate the incoming multiple emission lines 114, e.g., based on their wavelengths or wavelength ranges. Different amounts of energy released by the constituent atoms as a result of electrons dropping from a higher energy level to a lower energy level in the constituent atoms may correspond with different wavelengths or wavelength ranges of optical emission. As discussed previously, the specific amount of energy released may depend on the atomic structure, e.g., the energy levels of the electron orbits of the atom. Also, as previously discussed, each constituent element and/or compound may have its own unique atomic structure. Thus, by separating the incoming multiple emission lines by wavelengths and/or wavelength ranges, the diffraction grating device 116 may separate the multiple emission lines based on the element and/or compound associated with an optical emission. As shown in FIG. 1, the diffraction grating device 116 separates the multiple emission lines 114 by their element-specific wavelengths into separated emission lines 118, which may also be referred to as “emission lines” 118, “element-specific emission lines” 118, or “wavelength-specific emission lines” 118 for simplicity. The separated emission lines 118 may travel to, or be detected by, a respective detector device (e.g., detector 120A, detector 120B, etc.).

Detector devices 120A-120B can measure the intensity of each wavelength-specific emission line. The detector 120 may be a light-sensitive device that would transform the light received to image data. For example, detector 120 may be a charge coupled device (CCD) detector. A CCD detector, or other like detectors, may include various detector elements that may build up a charge based on the intensity of light. In some aspects of the present disclosure, other detectors of electromagnetic radiation may be used, e.g., photomultiplier tubes, photodiodes, and avalanche photodiodes, etc. The intensity measured from the individual optical emission lines 118 may be proportional to the concentration of the element in the sample. Furthermore, from the emission lines, the detector devices 120A-120B may collect the individual emission line's peak signals. Collectively or individually, the detector devices 120A-120B may process the received signals to generate a spectrum showing light intensity peaks as a function of wavelength. Also or alternatively, as shown in FIG. 1, the detector devices 120A-120B may send the signals received from the individual emission lines to a computing system 124 to be processed. The computing system 124 may receive the signals over any suitable communication medium, including a wireless network 122, as illustrated in FIG. 1. The processed signals may reveal which wavelengths of light are present in the light emitted by the sample 110 and the associated peak intensities. The wavelengths present in the spectrum may identify a constituent element or compound, and peak intensities may provide an indication of the quantity of the constituent element or compound in the sample 110.

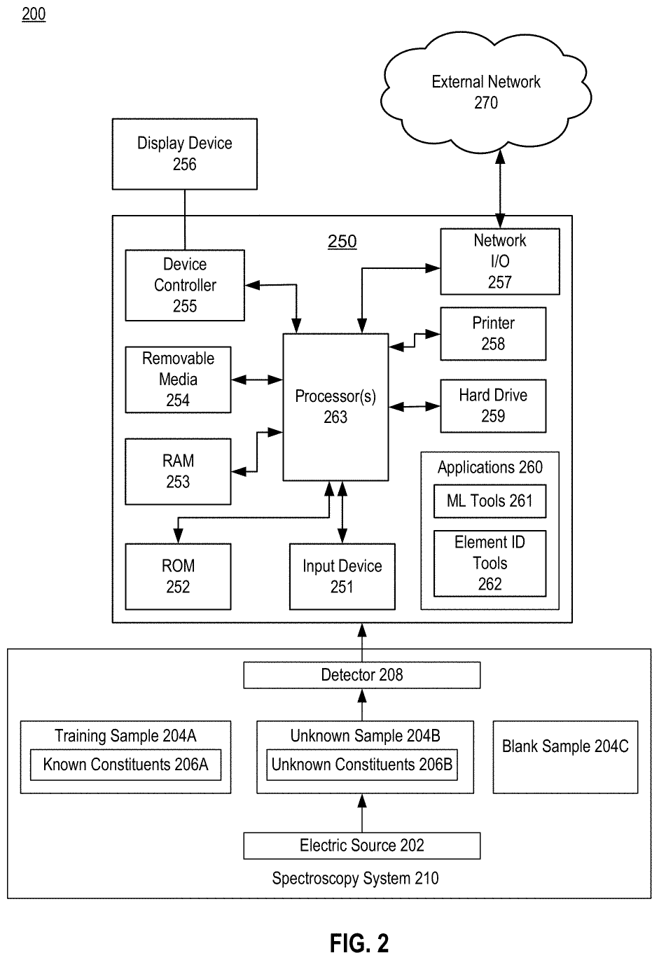

The computer system 124 may determine or acquire the measured intensities from the detectors 120A-120B and processes this data to determine the composition of the sample 110 using methods described herein. A user interface of the computer system 124 can be used to display, print or store the measured intensities, wavelengths, and/or estimated sample compositions. Furthermore, the computer system 124 may store and run applications for learning (e.g., via machine learning, convolution neural networks, etc.) from training samples to better predict the composition of a testing sample. More detail regarding the computer system 124 may be described in conjunction with FIG. 2.

It is to be noted that while FIG. 1 depicts an example OES system, other forms of imaging modality may be used to implement methods presented herein and to reap the benefits of the embodiments of the present disclosure. For example, in some aspects of the present disclosure, an OES imaging device could be replaced with one or more of an inductively coupled plasma optical emission spectrometry (ICP-OES) device, infrared spectroscopy device, nuclear magnetic resonance (NMR) spectroscopy device, an ultraviolet (UV) spectroscopy device, etc.

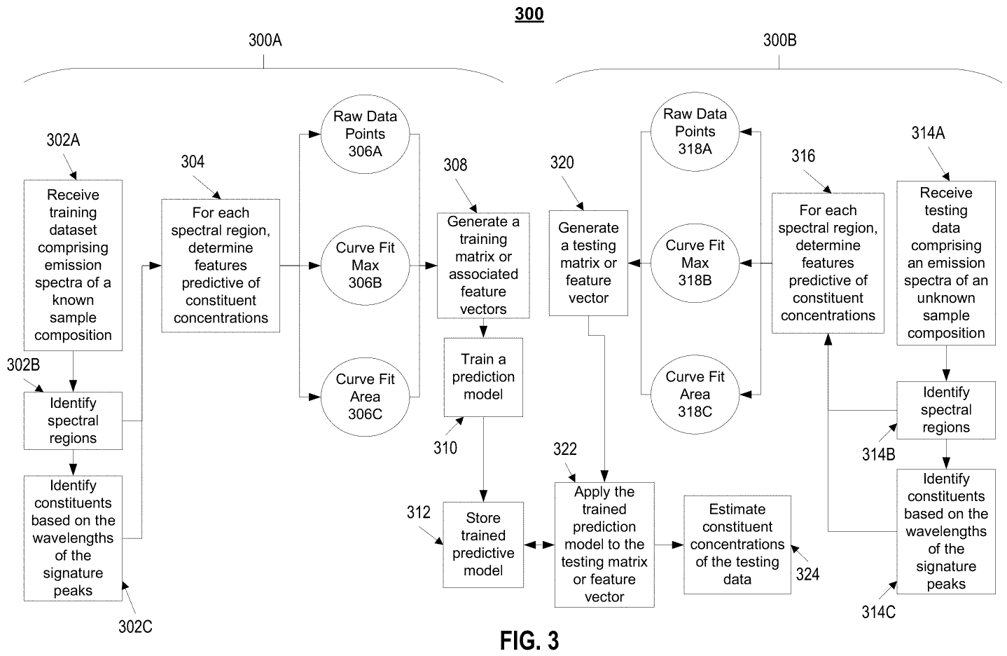

FIG. 2 illustrates a computing environment 200 that may be used to implement aspects of the disclosure. At a high level, the computing environment 200 may include the spectroscopy system 210 for generating an optical emission spectrum of a sample, and a computing system 250 for processing and analyzing the optical emission spectrum, performing a spectral interference correction without knowing the sample composition, and determining the sample composition after the spectral interference correction. As described above with reference to FIG. 1, electric source 202 may generate an discharge (e.g., of energy) to excite constituent atoms in the sample (e.g., training sample 204A, unknown sample 204B, blank sample 204C). As will be described further, in conjunction with FIGS. 3A and 3B, a training sample 204A may comprise known constituents, and therefore have a known sample composition. The interaction between the discharge and the sample may cause the sample to release an optical emission of various wavelengths and intensities, which may be received at a detector 208 (e.g., a CCD). The detector 208 may provide a signal corresponding to the detected spectrum to the input device 251 of the computing system 250. As will be discussed herein, the resulting optical emission spectrum from the training sample may be used to generate a prediction model to perform spectral interference correction without having to know the composition of an unknown sample (e.g., unknown sample 204B having unknown constituents 206B). Furthermore, as will be discussed, an optical emission spectrum resulting from a blank sample 204C, which includes minimal to no constituent elements or compounds, can be used to remove background noise from the optical emission spectrum resulting from the unknown sample 204B.

Still referring to FIG. 2, the computing system 250 can execute software that controls the operation of one or more instruments, and/or can process data obtained, e.g., from a user interface or from the spectroscopy system 210. The software may include one or more modules recorded on machine-readable media such as magnetic disks, magnetic tape, CD-ROM, and semiconductor memory, for example. The machine-readable medium may be resident within the computing system 250 or can be connected to the computing system 250 by a network I/O 257 (e.g., access via external network 270). However, in alternative examples, one can substitute computer instructions in the form of hardwired logic for software, or one can substitute firmware (i.e., computer instructions recorded on devices such as PROMs, EPROMS, EEPROMs, or the like) for software. The term machine-readable instructions as used herein is intended to encompass software, hardwired logic, firmware, object code and the like.

The computing system 250 may be programmed with specific instructions to perform the various image processing operations described herein. The computing system 250 can be, for example, a specially-programmed embedded computer, a personal computer such as a laptop or desktop computer, or another type of computer, that is capable of running the software, issuing suitable control commands, and/or recording information in real-time. The computing system 250 may include, be connected to, or be communicatively linked to a display 256 for reporting information to an operator of the instrument (e.g., displaying an optical emission spectrum, peak intensities, peak wavelengths, signature peaks, fitted curves, sample composition predictions, interfering element composition predictions, an indicia of spectral interference, etc.), an input device 251 (e.g., keyboard, mouse, interface with optical imaging system, etc.) for enabling the operator to enter information and commands, and/or a printer 258 for providing a print-out, or permanent record, of measurements made by the system and for printing images. Some commands entered at the keyboard may enable a user to perform certain data processing tasks. In some implementation, data acquisition and data processing are automated and require little or no user input after initializing the system.

The computing system 250 may comprise one or more processors 263, which may execute instructions of a computer program to perform any of the functions described herein. The instructions may be stored in a tangible, non-transitory computer medium, such as a read-only memory (ROM) 252, random access memory (RAM) 253, removable media 254 (e.g., a USB drive, a compact disk (CD), a digital versatile disk (DVD)), and/or in any other type of computer-readable medium or memory (collectively referred to as “electronic storage medium”). Instructions may also be stored in an attached (or internal) hard drive 259 or other types of storage media. The computing system 250 may comprise one or more output devices, such as a display device 256 (e.g., to view generated images, optical emission spectra, fitted curves, signature peaks, etc.) and a printer 258, and may comprise one or more output device controllers 255, such as an image processor for performing operations described herein. One or more user input devices 251 may comprise a remote control, a keyboard, a mouse, a touch screen (which may be integrated with the display device 256), etc. The computing system 250 may also comprise one or more network interfaces, such as a network input/output (I/O) interface 257 (e.g., a network card) to communicate with an external network 270. The network I/O interface 257 may be a wired interface (e.g., electrical, RF (via coax), optical (via fiber)), a wireless interface, or a combination of the two. The network I/O interface 257 may comprise a modem configured to communicate via the external network 270. The external network may comprise, for example, local area network, a network provider's wireless, coaxial, fiber, or hybrid fiber/coaxial distribution system (e.g., a DOCSIS network), or any other desired network.

One or more of the elements of the computing system 250 may be implemented as software or a combination of hardware and software. Modifications may be made to add, remove, combine, divide, etc. components of the computing system 250. Additionally, the elements shown in FIG. 2 may be implemented using computing devices and components that have been specially configured and programmed to perform operations such as are described herein. For example, a memory of the computing system 250 may store computer-executable instructions that, when executed by the processor 263 and/or one or more other processors of the computing system 250, cause the computing system 250 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

Computing system 250 may further include one or more applications 260 that may include stored programs, code, or instructions for running via processor 263. For example, applications 260 may include tools for performing various machine learning operations (e.g., machine learning (ML) tools 261), which may include training prediction models for determining the sample composition and spectral interference from an unknown sample. The applications 260 may further include an application for detecting one or more signature peaks from an optical emission spectrum and identifying a known element or compound from the at least one signature peak (element ID tool 262). The applications 260 may rely on an image processing of the optical emission spectrum received from the spectroscopy system 210. For example, the application may analyzed an image obtained after an optical emission spectrum has undergone image processing externally (e.g., at another computing system or at another component of computing system 250). Also or alternatively, the applications 260 may use the processor 263 to perform image processing on the optical emission spectrum to perform further analysis. FIG. 3 may provide more provide a more detailed embodiment of the methods performed by applications 260.

FIG. 3 depicts an example method 300 for analyzing unknown sample compositions using a prediction model based on optical emission spectra. One or more steps of method 300 can be performed by a computer system having one or more processors (e.g., as in computing environment 200 depicted in FIG. 2, and/or computing system 124 depicted in FIG. 1). Furthermore, the computing system may perform the one or more steps based on data (e.g., emission spectra) received from the OES system, e.g., via detector 120A, 120B, 208, etc. At a high level, method 300 may include a training phase 300A and application phase 300B. The training phase 300A includes one or more steps for training a prediction model that can estimate an unknown sample composition (e.g., identities and concentrations of the constituent elements and compounds of a sample). As will be discussed below, the training phase 300A may rely on at least one training sample comprising emission spectra of known sample compositions received from the spectroscopy system 210. The application phase 300B includes one or more steps for using the prediction model formed in the training phase 300A to predict the identities and concentrations of an unknown sample composition. It is to be appreciated that an unknown sample composition may include interfering constituent elements and compounds that may cause spectral interference to the optical emission of the sample's desired constituent elements and compounds. However, some embodiments presented herein overcome the spectral interference caused by the interfering elements by providing a more accurate estimation of the identities and concentrations of the desired constituent elements and compounds. Furthermore, some embodiments presented herein overcome the need to identify the interfering elements, as discussed previously.

Referring now to the training phase 300A of method 300, step 302A may include receiving a training dataset comprising emission spectra of a known sample composition. A sample composition may be known if the identities and concentrations of the constituent elements or compounds making up at least a significant part of the sample are known. The training dataset may thus include, as its domain, emission spectra for a plurality of sample compositions. Each emission spectra may include, for example, spectral regions characterized by a signature peak. The signature peak may be associated with a known element or compound. The training dataset may also include, as its range, the identity and concentration of constituent elements and compounds, of each of a plurality of samples. In some implementations, the training dataset may be stored in the computing system (e.g., within hard drive 259), and/or may be periodically updated via information regarding other known sample compositions and their respective emission spectra. ML tools 261 may be used to update and/or train a prediction model using the steps described herein. In some aspects, the training dataset may be supplied to the computing system, e.g., from external computing systems, servers, or libraries. In some embodiments, the received optical emission spectra may be digitized and analyzed via an image processor, e.g., for subsequent steps discussed herein. Furthermore, the emission spectra, and their respective known sample composition information (e.g., identities of sample constituents and their respective concentrations) may be stored, e.g., within data structures in ML tools 261 of applications 260 and/or within hard drive 259.

At step 302B, the computing system may identify or determine spectral regions from the received emission spectra. The spectral regions may be based on regions of an optical emission spectrum that involve a signature peak. For example, an optical emission spectrum may include a curve that fluctuates in intensity across a wavelength range. A signature peak would involve a markedly drastic increase in intensity around a specific wavelength or wavelength range. The signature peak may contrast with other regions of the curve where the fluctuations are relatively minor.

In some implementations, spectral regions and/or the signature peak of the spectral region may be identified using image processing techniques. For example, one such technique may involve searching for intensity values corresponding to an optical emission curve that exceed and/or fall below a predetermined threshold. Another technique may involve detecting a local or global maximum of the optical emission curve, and a corresponding local minimum on either side of the detected maximum. Based on the span of a signature peak, the optical emission curve may be cropped so that the spectral region comprises at least the wavelength range spanning the signature peak. It is contemplated that the spectral region may include peaks other than the signature peak (e.g., where the signature peak is flanked by one or more peaks of lesser intensity). In such examples, the optical emission curve may be cropped so that the spectral region comprises at least the wavelength range spanning the signature peak and minor peaks adjacent to the signature peak.

In some embodiments, a signature peak may be characteristic of a constituent element or compound. For example, the wavelength or wavelength range of the signature peak may indicate the amount of energy released as a result of electron transitions across energy levels in an atomic structure, as was previously discussed in conjunction with FIG. 1. Since each element and/or compound has a unique atomic structure with unique energy levels, energy released from electron transitions across these energy levels may also be unique for each element and/or compound. Thus, the wavelength or wavelength range of the signature peak can be used to identify an element or compound. Therefore, where applicable (e.g., where there is a clear signature peak), the computing system may identify constituents of the sample based on the wavelengths of the signature peaks (e.g., as in step 302C).

For each identified or determined spectral region of each emission spectrum, the computing system may determine one or more features of the spectral region that are predictive of constituent concentrations (e.g., step 304). For example, the one or more features may include, but are not limited to, the raw data points of the spectral region or a signature peak of spectral region 306A, a local or a global maximum of a fitted curve over the spectral region or over the signature peak of the spectral region (e.g., curve fit max 306B), or an area under a fitted curve of the spectral region or an area under a fitted curve of the signature peak of the spectral region (curve fit area 306C). Other features that may be predictive of constituent concentrations may include, for example, data associated with a peak other than a signature peak of a spectral region. For example, such features may include the raw data points of the peak different from the signature peak of the spectral region, a local or a global maximum of a fitted curve over the peak different from the signature peak of the spectral region, or an area under a fitted curve of the peak different from the signature peak of the spectral region.

In some implementations, step 304 may include determining features of the spectral region that is most predictive of the constituent concentrations by testing a plurality of data points from the spectral region. As discussed above, the actual constituent element or compound can be identified based on the signature peak of a spectral region, and the concentration may already be known because the training dataset may use known sample compositions. The testing of various data points may involve processing the data points using a convolutional neural network, which may involve assigning feature weights to the various data points of the spectral region based on how well they predict the constituent concentration.

The determined or identified features of the spectral region that are predictive of the constituent concentrations may not necessarily be the same for each constituent element or compound. For example, the training dataset may indicate that a curve fit max of a signature peak corresponding to element X is most predictive of element's X concentration in a sample, whereas the training dataset could indicate that a curve fit area of a signature peak corresponding to element Y is most predictive of element Y's concentration in a sample. In other implementations, the identified features of a spectral region that are predictive of the constituent's concentrations may be the same for various constituent elements or compounds. The identified or determined features may be saved in hard drive 259, e.g., by the ML Tool application 261. The saved features can be retrieved in the testing phase to determine the most predictive features of an unknown sample's optical emission to determine the unknown sample's composition.

After identifying features of the spectral region that are predictive of concentrations of the various constituents of the sample, the values for these features can be determined, calculated and/or measured.

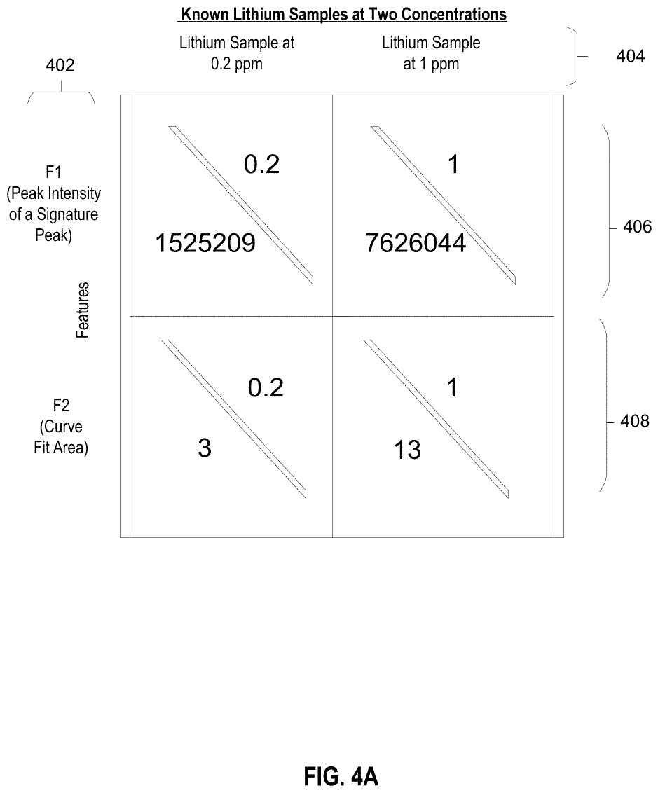

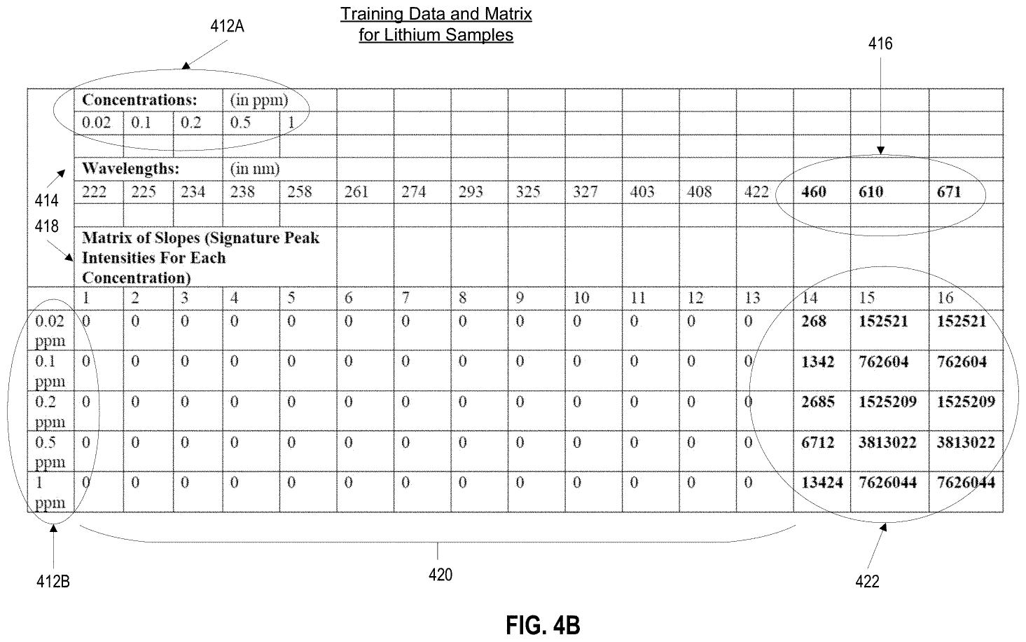

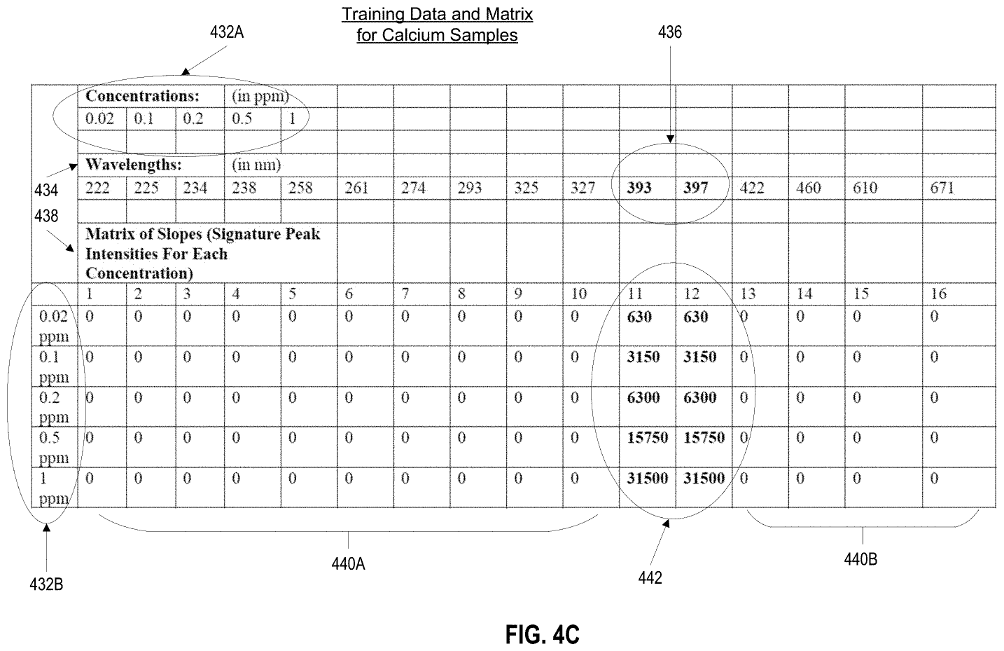

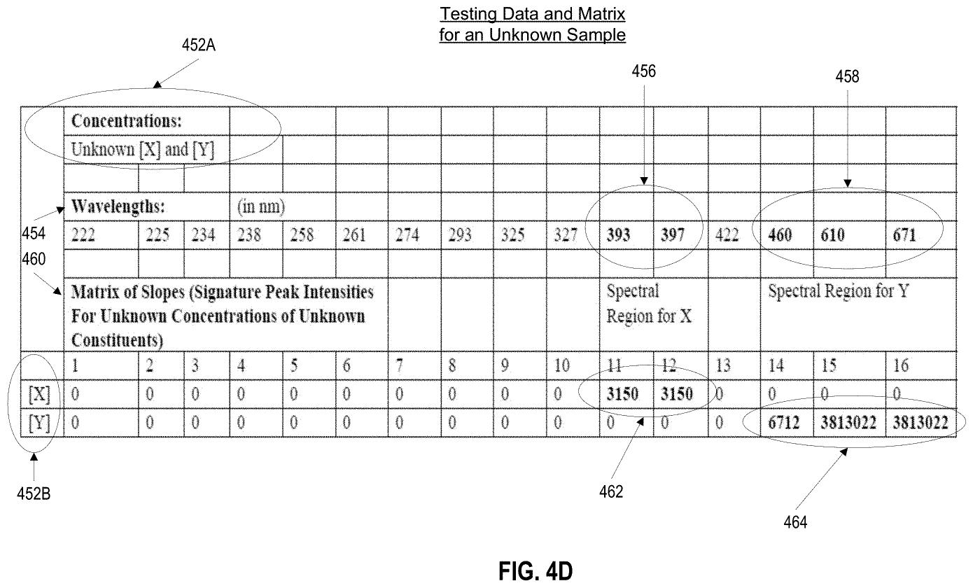

At step 308, the computing system may generate a training matrix, based on the values of the determined features that are predictive of the constituent concentrations, and the respective constituent concentrations. In some implementations, a training matrix may be generated for each known sample composition and its respective emission spectrum. Also or alternatively, the known sample compositions and the values of the determined features may be arranged in a form other than a matrix. For example, the values of the determined features that are predictive of the constituent concentrations may be arranged as a feature vector. The feature vector may assign or provide variables for weights based on how well a feature predicts the constituent concentration. FIGS. 4A through 4C depict example embodiments of training matrices.

At step 310, the computing system may train a prediction model, e.g., using the training matrix. The training may rely on one or more machine learning algorithms or statistical methods to determine a mathematical relation between values for the determined features predictive of the constituent's concentration, and the constituent's actual concentration. For example, the training may include using partial least squares regression to determine the mathematical relation between values for the determined features predictive of the constituent's concentration, and the constituent's actual concentration. In at least one embodiment, values for various features of the spectral region may be provided for a variety of constituents of known concentrations in a matrix. The features most predictive of the constituent's concentration as well as the mathematical relationships (e.g., slope) may be determined through the matrix.

Step 312 may include storing the trained prediction model in an electronic storage medium. For example learned relationships for the concentration of various elements and compounds and the features from the spectral region of the respective various elements and compounds can be stored by the ML Tool application 261 on hard drive 259. Since each element or compound, given their unique atomic structure, would provide unique optical emissions as a result of electron transitions, each element or compound can be identified by the wavelength or wavelength range of a unique signature peak. Depending on the spectral regions identified from a testing sample in subsequent steps, the mathematical relationship between features of a spectral region and the concentration can be obtained from the trained prediction model stored in step 312.

Referring now to the testing phase 300B of method 300, step 314A may include receiving testing data comprising an emission spectrum of an unknown sample composition. In contrast to the training dataset, which may comprise emission spectra from multiple samples of known sample composition, the testing data may comprise an emission spectrum for a sample for which knowledge of the sample's composition is desired. Furthermore, the sample corresponding to the testing data may include, along with analytes of interest, interfering elements and compounds that could cause spectral interference. As discussed previously, traditional methods of spectral interference correction may have involved knowing at least the composition (e.g., identities, concentration, etc.) of the interfering elements and compounds. Through the use of a prediction model from training phase 300A, various embodiments of the present disclosure may overcome the need to know the composition of the interfering elements and compounds. Furthermore, the various embodiments provide a more accurate determination of a sample's composition that compensates for the detrimental effects caused by spectral interference, by analyzing the sample's optical emission using the prediction model.

At step 314B, the computing system may identify or determine spectral regions from the received emission spectra. The spectral regions may be based on regions of an optical emission spectrum that involve a signature peak. For example, an optical emission spectrum may include a curve that fluctuates in intensity across a wavelength range. A signature peak would involve a markedly drastic increase in intensity around a specific wavelength or wavelength range. The signature peak may contrast with other regions of the curve where the fluctuations are relatively minor.

In some implementations, spectral regions and/or the signature peak of the spectral region may be identified using image processing techniques. For example, one such technique may involve searching for intensity values corresponding to an optical emission curve that exceed and/or fall below a predetermined threshold. Another technique may involve detecting a local or global maximum of the optical emission curve, and a corresponding local minimum on either side of the detected maximum. Based on the span of the signature peak, the optical emission curve may be cropped so that the spectral region comprises at least the wavelength range spanning the signature peak. It is contemplated that the spectral region may include peaks other than the signature peak (e.g., where the signature peak is flanked by one or more peaks of lesser intensity). In such examples, the optical emission curve may be cropped so that the spectral region comprises at least the wavelength range spanning the signature peak and minor peaks adjacent to the signature peak.

It is to be appreciated that a signature peak may be characteristic of a constituent element or compound. For example, the wavelength or wavelength range of the signature peak of may indicate the amount of energy released as a result of electron transitions across energy levels in an atomic structure, as was previously discussed in conjunction with FIG. 1. Since each element and/or compounds has a unique atomic structure with unique energy levels, then energy released from electron transitions across these energy levels may also be unique for each element and/or compound. Thus, the wavelength or wavelength range of the signature peak can be used to identify an element or compound. Therefore, where applicable (e.g., where there is a clear signature peak), the computing system may identify constituents of the sample based on the wavelengths of the signature peaks (e.g., as in step 314C).

For each identified or determined spectral region of each emission spectrum, the computing system may determine one or more features of the spectral region that are predictive of constituent concentrations (e.g., step 316). However, since the constituent concentrations of the testing data is unknown, the features may be determined from the training phase 300A. Based on the identified or determined spectral regions (e.g., from step 314B), and the identified constituent elements or compounds from the signature peaks of the spectral regions (e.g., from step 314C), the computing system may retrieve features determined to be predictive of the identified constituent's concentration, e.g., from step 304.

As previously discussed, the one or more features may include, but are not limited to, the raw data points of the spectral region or a signature peak of spectral region 318A, a local or a global maximum of a fitted curve over the spectral region or over the signature peak of the spectral region (e.g., curve fit max 318B), or an area under a fitted curve of the spectral region or an are under a fitted curve of the signature peak of the spectral region (curve fit area 318C). Also as previously discussed, other features that may be predictive of constituent concentrations may include, for example, data associated with a peak other than a signature peak of a spectral region.

It is contemplated that the computing system may already have a stored list of predictive features to use based on the constituent element and/or compound identified from the signature peaks of the emission spectra of the unknown sample. As discussed previously in conjunction with the training phase 300A, the stored list of predictive features may be determined based on training from a variety of known sample compositions, which happen to have the constituent elements and compounds identified in the testing dataset.

Based on the features of the spectral region that are prescribed (based on the results of the training phase 300A) to be most predictive of the constituent concentrations, the values for these features can be calculated and/or measured.

The computing system may then use the prediction model trained in the training phase to estimate or predict the constituent concentrations of the unknown sample composition using the determined features from step 316. In at least one implementation, the computing system may generate feature vectors and/or a testing matrix, based on the values of the determined features that are predictive of the constituent concentrations (e.g., as in step 320). Since the constituent concentrations for the testing data are unknown, the feature vectors may be inputted into the prediction model stored in step 312 to estimate the constituent concentrations of the testing data (e.g., as in step 324). For example, weights may be assigned to the feature vector based on how well a feature predicts the constituent concentration. Mathematical relationships learned from the prediction model may thus be applied to the feature vector to calculate the concentration of constituent elements or compounds of the unknown sample that is being tested.

Also or alternatively, the determined features may be used to form a testing matrix where the constituent concentrations are yet unknown. An example of the testing matrix is shown and explained in conjunction with FIG. 4D. The prediction model may be applied to the testing matrix (e.g., as in step 322) to estimate the constituent concentrations of the unknown sample composition (e.g., as in step 324). The estimated constituent concentrations and their identities may be displayed to a user of the computing system via display device 256, stored in hard drive 259, or printed using printer 258. In some implementations, a user may be able to determine further information regarding a constituent element or compound, e.g., using input device 251. For example, a user may be able to view the signature peak of the optical emission that was used to identify the constituent element or compound, or determine a confidence level of the estimated concentration of the constituent element or compound.

It is contemplated that the constituent elements or compounds, whose identities and concentrations are determined or estimated using the steps presented in testing phase 300B may include desired analytes as well as interfering elements or compounds. As discussed previously, in traditional methods, the interfering elements or compounds may typically affect accurate determination of a sample composition by causing spectral interference. However, by relying on a prediction model trained through the use of a plurality of known sample compositions and their respective optical emission spectra, various embodiments of the present disclosure overcome the problems caused by spectral interference.

FIGS. 4A-4D depict example training and testing matrices used for generating and applying a prediction model used in various aspects of the present disclosure. The training matrices, as shown in FIGS. 4A-4C and the testing matrix, as shown in FIG. 4D, may be used in one or more steps of the training phase 300A and testing phase 300B, respectively, of method 300 of FIG. 3. For example a training matrix, as shown in FIG. 4A may be used to determine a feature of a spectral region of an optical emission spectra of known sample compositions (e.g., Lithium samples at various concentrations) that is predictive of the concentrations of the sample's constituents (e.g., as in step 304 in FIG. 3). FIGS. 4B and 4C depict the use of the determined feature (e.g., peak intensity of signature peaks) in training matrices to determine a prediction model between the determined feature and a sample composition (e.g., concentration of a constituent element or compound). For example, FIGS. 4B and 4C each depict an example training matrix for a known sample composition of Lithium and a known sample composition of Calcium, respectively. Thus, the training matrices of FIGS. 4B and 4C may be used to train a prediction model, e.g., by determining mathematical relationships, for predicting the concentration of Lithium and Calcium in an unknown sample using features from the spectral regions (e.g., as in step 310 in FIG. 3). A testing matrix, as shown in FIG. 4D, may be used to apply the prediction models (e.g., based on training matrices shown in FIGS. 4B and 4C) to estimate the constituent concentrations of an unknown sample composition (e.g., as in steps 323-324)

Referring now to FIG. 4A, training matrix 400 may be used to determine which feature, among a plurality of features of a spectral region corresponding to a constituent, may be the most predictive feature for predicting a concentration of a constituent. As shown in FIG. 4A, the example constituent being used in the training is Lithium, in a sample with a concentration of 0.2 parts per million (ppm) and in a sample with a concentration of 1 ppm (e.g., as shown by marker 404).

The rows 402 of the matrix may each correspond to a different feature of the spectral region of the emission spectra of the Lithium samples. The different features may be tested for their ability to predict a constituent's concentration using a training matrix such as training matrix 400A. For example, the feature tested in the first row is the maximum point of a signature peak of the spectral region (“peak intensity of a signature peak”) corresponding to the two Lithium samples. The feature tested in the second row is an area under the fitted curve of the signature peak of the spectral region (“curve fit area”) corresponding to the two Lithium samples. Other rows may be added to correspond with other features of the spectral region of a constituent (e.g., as in Lithium as shown in matrix 400A). Thus, different features may be tested for their ability to predict a constituent's concentration.

The columns 404 of the matrix may each correspond to a different concentration of a constituent that has been identified or hypothesized as being within a sample composition. Thus, in the example training matrix 400, the columns correspond to a Lithium sample at a concentration 0.2 ppm and a Lithium sample at a concentration of 1 ppm. As explained previously, a wavelength or wavelength range of a signature peak may be used to identify or hypothesize the existence of a specific element or compound in a sample composition. Within each row of each constituent, the constituent's concentration may be used in the determination of a mathematical relationship between the concentration and a feature of the spectral region, e.g., to determine the feature that is most predictive of the constituent's concentration. For each entry of the training matrix, the constituent's concentration is shown to be listed above a value corresponding to a feature of the spectral region. While a constituent's concentration may be known for sample compositions being used in the training dataset, the constituent's concentration may not be known for the sample composition being tested. Thus, as will be shown in the testing matrix used in FIG. 4D, the concentrations of the constituents X and Y would be unknown and would be determined using the methods presented herein.

As shown in training matrix of FIG. 4A, the relationship between feature F1 and the constituent concentration appears to be linear. This can be seen because the ratio of a 0.2 ppm concentration of Lithium to the value of feature F1 for that concentration, 1525209, yields 1.31*10⁻⁷, while the ratio of a 1 ppm concentration of Lithium to the value of feature F1 for that concentration, 7626044, also yields 1.31*10⁻⁷. As shown in row 406, the linearity and the consistency of the determined mathematical relation (e.g., the slope of 1.31*10⁻⁷) shows that F1 is fairly predictive in estimating a constituent's concentration. In contrast, the ratio of a 0.2 ppm concentration of Lithium to the corresponding value of feature F2, 3, yields 0.067, while the ratio of the 1 ppm concentration of Lithium to the corresponding value of feature F2, 13, yields 0.077. Since the mathematical relationship between feature F2 and the constituent concentration is not as consistent, F2 may not be as predictive of a feature as F1 for estimating constituent concentrations. Nevertheless, one or more features of a spectral region may be more predictive for the concentrations of certain constituent elements or compounds but not as predictive for the concentrations of other constituent elements or compounds. Furthermore, mathematical relationships between a feature of the spectral region and the concentration of a constituent need not be linear or indicated as a slope. As a result, prediction models need not be based on a matrix of slopes. After determining that feature F1 (e.g., peak intensity of a signature peak) is the most predictive in determining the concentration of the constituent, methods to determine a prediction model (e.g., a machine learning algorithm, a mathematical relation, etc.) between the feature and the concentration will be discussed, in conjunction with FIGS. 4B and 4C.

FIG. 4B shows a matrix with training data for a known sample composition for Lithium. The training data may be used to determine a prediction model (e.g., a machine learning algorithm, a mathematical relation, etc.) between a composition (e.g., the concentration for Lithium) and a feature (e.g., a peak intensity of a signature peak). The specific feature to be used (e.g., peak intensity of a signature peak) may be determined using methods presented above, in conjunction with FIG. 4A. In the instant example shown in FIG. 4B, it was determined that the peak intensity of a signature peak is the most predictive feature for predicting the concentration of Lithium, and therefore this feature will be used to determine the prediction model, as will be explained herein.

Referring now to FIG. 4B, markers 412A and 412B indicates that the matrix includes training data for five samples of Lithium, the samples having concentrations of 0.02 ppm, 0.1 ppm, 0.2 ppm, 0.5 ppm, and 1 ppm. The emission spectra of each sample of Lithium may reflect commonalities as a result of Lithium being a common constituent. For example, the emission spectra for the Lithium samples may produce peaks, amplifications, and/or minor fluctuations at or near specific wavelengths. As shown by marker 414, these specific wavelengths may include, e.g., 222 nanometers (nm), 225 nm, 234 nm, 238 nm, 258 nm, 261 nm, 274 nm, 293 nm, 325 nm, 327 nm, 403 nm, 408 nm, 422 nm, 460 nm, 610 nm, and 671 nm. A training matrix 418 may indicate values for a feature of the emission spectra being measured at these specific wavelengths. The feature of the emission spectra may include, for example: an area under the peak, the amplification, and/or the minor fluctuation; a data point (e.g., maximum and/or peak intensity, minimum intensity, intensity at an inflection point, intensity at a local maxima, intensity at a local minima, etc.) associated with the peak, the amplification, and/or the minor fluctuation; a measurement of a boundary of the peak, the amplification, and/or the minor fluctuation; or a fitted curve of the peak, amplification, and/or minor fluctuation.

As shown in marker 418, the feature which is being measured at these specific wavelengths is the peak intensity. However, a value for a peak intensity (or any other feature) at one or more of these specific wavelengths may be insignificant, for example, because the value may not satisfy a threshold. As shown by marker 420, values that do not meet a threshold may be rendered null (e.g., “0”) in order to discard the peak, amplification, and/or minor fluctuation at the wavelengths corresponding to each of those values as background noise.

Nevertheless, as shown by marker 422, the values of the peak intensities for some wavelengths of the emission spectra may be sufficiently high (e.g., because the values satisfy a threshold). For Lithium, these peak intensities may be centered at or near wavelengths of 460 nm, 610 nm, and 671 nm, as shown by marker 416. The peaks corresponding to these wavelengths may be identified as the signature peaks for Lithium. As previously discussed, each known constituent element or compound may be identifiable by their signature peaks. The training matrix 418 may indicate the values of a feature (e.g., peak intensity values) at these signature peaks for the emission spectrum of each sample (e.g. Lithium samples at 0.02 ppm, 0.1 ppm, 0.2 ppm, 0.5 ppm, and 1 ppm, respectively). Thus, the intensity values for the signature peaks for a Lithium sample at 0.5 ppm may include 6,712 at 460 nm, 3,813,022 at 610 nm, and 3,813,022 at 671 nm.

The training matrix (e.g., matrix 418) may be used to determine a prediction model (e.g., a machine learning algorithm, a mathematical relation, etc.) between the concentration of a constituent (e.g., Lithium) and the value of a feature of the emission spectra (e.g., intensity value at the signature peaks). As shown in the matrix 418, there may be a linear relationship between the concentration of Lithium in a sample and the intensity value for each of the signature peaks of the emission spectra of the sample. For example, the intensity value for the signature peak at the wavelength of 460 nm is 268 for a Lithium sample of 0.02 ppm concentration. For a Lithium sample of 0.1 ppm, the signature peak at the wavelength of 460 nm may yield an intensity value of 1342. In both examples, for signature peaks at or near the 460 nm wavelength, the ratio of the concentration to the intensity value is 7.5×10⁻⁵. As can be seen from matrix 418, this ratio of the concentration of Lithium to the intensity value of a signature peak at the 460 nm wavelength may also apply for other concentrations of Lithium. For the signature peaks at the 610 nm and 671 nm wavelengths, the intensity value may be the same for the Lithium sample of 0.02 ppm concentration, e.g., at approximately 152521, as shown in FIG. 4B. For the Lithium sample of 0.1 ppm concentration, the intensity value for the signature peaks at the 610 nm and 671 nm wavelengths may also be the same, e.g., at approximately 762604, as shown in FIG. 4B. For the signature peaks at the 610 nm and 671 nm wavelengths for both of these concentrations, the ratio of the concentration to the intensity value of the respective signature peaks are 1.3×10⁻⁷. This ratio of the concentration of Lithium to the intensity value of signature peaks at the 610 nm and 671 nm wavelengths may also apply for the signature peaks at these wavelengths for the other concentrations of Lithium (e.g., 0.2 ppm, 0.5 ppm, 1 ppm, etc.).

Thus the training matrix shown in FIG. 4B may provide a prediction model for determining the concentration of Lithium in a sample based on specific linear relationships for three signature peaks. The linear relationship may be based on a slope of 7.5×10⁻⁵ for the signature peak at or near the wavelength of 460 nm and may be based on slopes of 1.3×10⁻⁷ at or near the wavelengths of 610 nm and 671 nm). As will be discussed, the prediction model based on these linear relationships may be used to determine the concentration of Lithium from an unknown sample through a testing matrix.

As noted above, the constituent element or compounds of an unknown sample may be identified by their signature peaks on the emission spectra of the unknown sample. Thus, training matrices, their corresponding training data, and their resulting prediction models may vary for each compound or element. For example, while FIG. 4B depicts the training matrix and training data for Lithium, FIG. 4C depicts the training matrix and training data for Calcium.

Referring now to FIG. 4C, markers 432A and 432B indicates that the matrix includes training data for five samples of Calcium (e.g., at concentrations of 0.02 ppm, 0.1 ppm, 0.2 ppm, 0.5 ppm, and 1 ppm, respectively). The samples may produce emission spectra that reflect commonalities (e.g., signature peaks) as a result of Calcium being a common constituent in the samples. The emission spectra may also produce peaks, amplifications, and/or minor fluctuations at specific wavelengths (e.g., as indicated by marker 434). However, these specific wavelengths for Calcium may or may not necessarily overlap with those of other elements or compounds. A training matrix 438 may indicate values for a feature of the emission spectra being measured at these specific wavelengths. As shown by the training matrix 438 in FIG. 4C, the feature which is being measured may be the peak intensity. The values for peak intensity at some of these wavelengths may be insignificant because they do not satisfy a threshold. As shown by markers 440A and 440B, the values that do not meet the threshold may be rendered null (e.g., “0”) in order to discard them as background noise. As shown by marker 442, the values of the peak intensities for some wavelengths of the emission spectra may be sufficiently high (e.g., by satisfying the threshold), and may be identified as the signature peaks for Calcium. These signature peaks may be centered at or near wavelengths of 393 nm and 397 nm, as shown by marker 436. Since constituent elements and/or compounds may be identifiable by their signature peaks, the signature peaks for Calcium are thus located at different wavelengths than the signature peaks for Lithium. The training matrix 438 may indicate the peak intensity at these signature peaks for the emission spectrum of each sample of Calcium (e.g. Calcium samples at concentrations of 0.02 ppm, 0.1 ppm, 0.2 ppm, 0.5 ppm, 1 ppm, respectively).

There may also be a linear relationship between the concentration of Calcium and the intensity value for each of the signature peaks. For example, the intensity value for a signature peak at or near the 393 nm wavelength is 630 for a Calcium sample of 0.02 ppm concentration. For a signature peak at or near the 393 nm wavelength, the intensity value is 3150 for a Calcium sample of 0.1 ppm concentration. For both concentrations at or near the 393 nm wavelength, the ratio of the concentration to the intensity value is 3.2×10⁻⁵. The ratio may also apply for the signature peaks of other concentrations of Calcium at or near the 393 nm wavelength. For the signature peaks at the wavelength of 397 nm, the intensity value is also 630 nm for the Calcium sample of 0.02 ppm concentration and also 3150 for the Calcium sample of 0.1 ppm concentration. Thus, for both examples at or near this wavelength, the ratio of the concentration to the intensity value may remain as 3.2×10⁻⁵, and may also apply for the other concentrations of Calcium at these wavelengths. Thus the training matrix shown in FIG. 4C may provide a prediction model for determining the concentration of Calcium. However, unlike the prediction model for Lithium shown in FIG. 4B, the prediction model for Calcium may be based on a specific linear relationship for both of its signature peaks. The linear relationship may be based a slope of 3.2×10⁻⁵ for signature peaks at or near the wavelengths of 393 nm and 397 nm. As will be discussed, the prediction model based on these linear relationships may be used to determine the concentration of Calcium from an unknown sample through a testing matrix after Calcium has been identified based on the signature peaks of the emission spectra of the unknown sample.

In some embodiments the process of determining which feature is most predictive for determining a sample composition (e.g., as explained in relation to FIG. 4A), the process of determining a prediction model between the predictive feature and the concentration (e.g., as explained in relation to FIGS. 4B and 4C) may be combined. For example, a machine learning algorithm may be trained using feature vectors or feature matrices associated with known concentrations of a constituent. The feature vectors or feature matrices may comprise of a variety of features of a spectral region of the emission spectra of the constituent sample. Thus, the feature vectors of feature matrices may include, for example, an area under a spectral region; a data point (e.g., maximum and/or peak intensity, minimum intensity, intensity at an inflection point, intensity at a local maxima, intensity at a local minima, etc.) associated with the spectral region; a measurement of a boundary of the spectral region; and/or a fitted curve of a peak, amplification, and/or minor fluctuation of the spectral region.

FIG. 4D depicts an example testing matrix for applying prediction models to determine an unknown sample composition. The unknown sample composition may comprise unknown constituents X and Y having unknown concentrations [X] and [Y], as shown in markers 452A and 452B. An emission spectra based on the unknown sample may be generated. The emission spectra of the unknown sample may include peaks, amplifications, and/or minor fluctuations at specific wavelengths (e.g., as indicated by marker 454). These specific wavelengths may or may not necessarily overlap with those of other elements or compounds. A matrix 460 may indicate values for a feature of the emission spectra being measured at these specific wavelengths. As shown by the matrix 460 in FIG. 4D, the feature which is being measured may be the peak intensity. Peak intensities having insignificant values (e.g., because they do not satisfy a threshold) may be rendered null (e.g., “0”) in order to discard them as background noise. Signature peaks and/or spectral regions based around clusters of signature peaks (e.g., as in markers 456 and 458) may be identified from the emission spectra. The identification may be based on the values of the peak intensities for some wavelengths of the emission spectra being sufficiently high (e.g., by satisfying the threshold). Constituent elements and/or compounds may be identified by their signature peaks or by spectral regions comprising their signature peaks. Thus, the spectral region 456 comprising of signature peaks at 393 nm and 397 nm may indicate the presence of Calcium. The spectral region 458 comprising of signature peaks at 460 nm, 610 nm and 671 nm may indicate the presence of Lithium. The signature peaks may be identified based on training data (e.g., as in FIG. 4B and FIG. 4C) and known information (e.g., signature peaks) about elements and compounds.

For each of the signature peaks of each of the spectral regions corresponding to the identified constituents, the peak intensity (and/or other features of the signature peak) can be measured. Thus, as shown in FIG. 4D, the signature peaks for Calcium at wavelengths of 393 nm and 397 nm each yield an intensity of 3150 (e.g., as shown by marker 462). Based on the prediction model for Calcium discussed in conjunction with FIG. 4C, there may be a linear relationship between the concentration of Calcium and the intensity value based on a ratio of 3.2×10⁻⁵. Thus, with an intensity value of 3150 for both of the signature peaks for Calcium, the concentration of Calcium in the unknown sample may be 0.1 ppm.

As shown by marker 464, the signature peak for Lithium at wavelength of 460 nm yields an intensity of 6712. Based on the prediction model for Lithium at a signature peak at or near the wavelength of 460 nm, as discussed in conjunction with FIG. 4B, there may be a linear relationship between the concentration of Lithium and the intensity value of the signature peak based on a ratio of 7.5×10⁻⁵. Thus, with an intensity value of 6712 for the signature peak at the wavelength of 460 nm, the concentration of Lithium in the unknown sample may be 0.5 ppm.

It is contemplated that methods, systems, and processes described herein encompass variations and adaptations developed using information from the examples described herein. While the disclosures have been particularly shown and described with reference to example implementations, it should be understood by those skilled in the art that various changes in form and detail may be made therein without departing from the spirit and scope of claimed subject matter.

Throughout the description, where systems and compositions are described as having, including, or comprising specific components, or where processes and methods are described as having, including, or comprising specific steps, it is contemplated that, additionally, there are systems and compositions of the present disclosure that consist essentially of, or consist of, the recited components, and that there are processes and methods of the present disclosure that consist essentially of, or consist of, the recited processing steps.

What is claimed is:

1. A method comprising:
receiving first emission spectra corresponding to a training sample comprising a plurality of pure elements of known concentrations;
determining, based on the first emission spectra corresponding to the training sample, a plurality of spectral regions corresponding to the plurality of pure elements of known concentrations, wherein each of the plurality of spectral regions is respective to each of the plurality of pure elements of known concentrations;
determining, for each of the plurality of spectral regions respective to each of the plurality of pure elements of the known concentrations, one or more features associated with a signature peak of a given spectral region;
forming, for each of the plurality of spectral regions respective to each of the plurality of pure elements of the known concentrations, a feature vector comprising the one or more features associated with the signature peak of the given spectral region;
associating, for each of the plurality of spectral regions respective to each of the plurality of pure elements of the known concentration, the feature vector with a known concentration of a pure element corresponding to the given spectral region;
training, based on the associated feature vectors, a prediction model to predict unknown concentrations of a plurality of constituents of an unknown sample;
receiving, from one or more detectors of an imaging modality, second emission spectra corresponding to the unknown sample comprising a plurality of constituents of unknown concentrations; and
generating, based on the application of the trained prediction model, a concentration for each of the constituents of the unknown sample.

2. The method of claim 1, wherein the one or more features associated with the signature peak of the given spectral region comprise one or more characteristics of the given spectral region or the signature peak of the given spectral region, and wherein the one or more characteristics comprise one or more of:
an area of the given spectral region or of the signature peak of the given spectral region;
a data point associated with the given spectral region or associated with the signature peak of the given spectral region;
a measurement of a boundary of the given spectral region or of a boundary of the signature peak of the given spectral region; or
a fitted curve of the given spectral region or of the signature peak of the given spectral region.

3. The method of claim 1, wherein the determining the one or more features associated with the signature peak of the given spectral region further comprises:
inputting a portion of the first emission spectra corresponding to the given spectral region into a convolutional neural network to determine one or more features that are predictive of the known concentration of the pure element corresponding to the given spectral region.

4. The method of claim 3, wherein the convolutional neural network comprises a plurality of filters that detect a characteristic of one or more of the given spectral region or the signature peak of the given spectral region, and wherein the characteristic comprises one or more of:
an area of the given spectral region or of the signature peak of the given spectral region;
a data point associated the given spectral region or associated with the signature peak of the given spectral region;
a measurement of a boundary of the given spectral region or of a boundary of the signature peak of the given spectral region; or
a fitted curve of the given spectral region or of the signature peak of the given spectral region.

5. The method of claim 1, wherein the determining the one or more features associated with the signature peak of the given spectral region further comprises:
generating a representative value of the signature peak of the given spectral region, and wherein the one or more features includes the representative value of the signature peak of the given spectral region.

6. The method of claim 5, wherein the generating the representative value of the signature peak of the given spectral region comprises:
determining a peak intensity of the signature peak of the given spectral region.

7. The method of claim 5, wherein the generating the representative value of the signature peak of the given spectral region further comprises:
performing one or more of a Gaussian curve fitting or a cubic spline interpolation of the signature peak of the given spectral region to produce a fitted peak curve.

8. The method of claim 5, wherein the generating the representative value of the signature peak of the given spectral region further comprises:
integrating the fitted peak curve to determine an area of the fitted peak curve, and wherein the representative value of the signature peak of the given spectral region is the area of the fitted peak curve.

9. The method of claim 1, wherein the associating, for each of the plurality of spectral regions, the feature vector further comprises:
forming a matrix comprising, for each of the plurality of spectral regions, a value based on the feature vector and the known concentration of the pure element corresponding to the given spectral region.

10. The method of claim 1, wherein the training the prediction model comprises determining, for each spectral region corresponding to each pure element of the known concentration, a linear relation between the one or more features associated with the signature peak of the given spectral region and the known concentration of the pure element corresponding to the given spectral region.

11. The method of claim 10, wherein the determining the linear relation comprises:
performing, for each of the plurality of spectral regions respective to each of the plurality of pure elements of the known concentrations, a least square linear regression between the feature vector and a known concentration of a pure element corresponding to the given spectral region.

12. The method of claim 1, wherein the generating the concentration for each of the constituents of the unknown sample comprises:
determining, based on the second emission spectra, a plurality of spectral regions corresponding to the plurality of the constituents of the unknown concentrations, wherein each of the plurality of spectral regions is respective to each of the plurality of the constituents of the unknown concentrations;
determining, for each of the plurality of spectral regions respective to each of the plurality of constituents of the unknown concentrations, one or more features associated with a signature peak of the given spectral region corresponding to a constituent of an unknown concentration;
forming, for each of the plurality of spectral regions respective to each of the plurality of the constituents of the unknown concentrations, a feature vector comprising of the one or more features associated with the signature peak of the given spectral region corresponding to the constituent of the unknown concentration; and
applying, for each of the plurality of spectral regions respective to each of the plurality of the constituents of the unknown concentration, the feature vector into the trained machine learning algorithm.

13. The method of claim 12, further comprising:
determining, for each of the plurality of the constituents and based on the spectral region respective to each of the plurality of the constituents of the unknown concentration, an identification of the constituent.

14. The method of claim 12, wherein the applying the feature vector into the trained prediction model comprises performing a least square linear regression.

15. The method of claim 1, further comprising:
receiving, from the emission filter, a third emission spectra corresponding to a blank sample, wherein the blank sample does not comprise the plurality of pure elements of the known concentrations, and wherein the determining the plurality of the spectral regions corresponding to the plurality of the pure elements of the known concentrations is further based on the third emission spectra corresponding to the blank sample.

16. A system comprising:
one or more detectors of an imaging modality that provides emission spectra; and
a computing device storing instructions that, when executed by one or more processors of the computing device, cause the computing device to:
receive first emission spectra corresponding to a training sample comprising a plurality of pure elements of known concentrations;
determine, based on the first emission spectra corresponding to the training sample, a plurality of spectral regions corresponding to the plurality of pure elements of known concentrations, wherein each of the plurality of spectral regions is respective to each of the pure elements of known concentrations;
determine, for each of the plurality of spectral regions respective to each of the plurality of pure elements of the known concentrations, one or more features associated with a signature peak of a given spectral region;
form, for each of the plurality of spectral regions respective to each of the plurality of pure elements of the known concentrations, a feature vector comprising the one or more features associated with the signature peak of the given spectral region;
associate, for each of the plurality of spectral regions respective to each of the plurality of pure elements of the known concentrations, the feature vector with a known concentration of a pure element corresponding to the given spectral region;
train, based on the associated feature vectors, a prediction model to predict unknown concentrations of a plurality of constituents of an unknown sample;
receive, from the one or more detectors, second emission spectra corresponding to the unknown sample comprising a plurality of constituents of unknown concentrations; and
generate, based on the application of the trained prediction model, a concentration for each of the constituents of the unknown sample.

17. The system of claim 16, wherein the imaging modality is one or more of an inductively coupled plasma optical emission spectrometry (ICP-OES), an infrared spectroscopy, a nuclear magnetic resonance (NMR) spectroscopy, an ultraviolet (UV) spectroscopy, an atomic fluorescence spectrometry, a flame emission spectrometry, a spark and arc emission spectrometry, an inductively coupled plasma mass spectrometry, a quadrupole based mass spectrometry of organic molecules, a time-of-flight mass spectrometry, a magnetic sector mass spectrometry, a trap-based mass spectrometry, a Fourier Transform ion cyclotron mass spectrometry, ion mobility spectrometry, and a differential mobility spectrometry.

18. The system of claim 16, wherein the instructions, when executed by the one or more processors, further cause the computing device to:
determine, based on the second emission spectra, a plurality of spectral regions corresponding to the plurality of constituents of unknown concentrations, wherein each of the plurality of spectral regions is respective to each of the plurality of constituents of the unknown concentrations;
determine, for each of the plurality of spectral regions respective to each of the plurality of constituents of the unknown concentrations, one or more features associated with a signature peak of a given spectral region corresponding to a constituent of an unknown concentration;
form, for each of the plurality of spectral regions respective to each of the plurality of constituents of the unknown concentrations, a feature vector comprising of the one or more features associated with the signature peak of the given spectral region corresponding to the constituent of the unknown concentration; and
apply, for each of the plurality of spectral regions respective to each of the plurality of constituents of the unknown concentrations, the feature vector into the trained machine learning algorithm.

19. A method comprising:
receiving, from an emission filter, emission spectra corresponding to a sample comprising a plurality of constituents of unknown concentrations;
determining, based on the emission spectra, a plurality of spectral regions corresponding to the plurality of the constituents of the unknown concentrations;
determining, for each of the plurality of spectral regions corresponding to each of the plurality of constituents of the unknown concentrations, one or more features associated with a signature peak of a given spectral region corresponding to a constituent of an unknown concentration;
forming, for each of the plurality of spectral regions corresponding to each of the plurality of constituents of the unknown concentrations, a feature vector comprising of the one or more features associated with the signature peak of the given spectral region corresponding to the constituent of the unknown concentration;
applying, for each of the plurality of spectral regions corresponding to each of the plurality of constituents of the unknown concentrations, the feature vector into a trained machine learning algorithm, wherein the trained machine learning algorithm is based on a learned relationship between a concentration of a pure element and one or more features associated with a signature peak of the pure element; and
generating, based on the application of the trained machine learning algorithm, an estimated concentration for each of the constituents of unknown concentration.

20. The method of claim 19, further comprising, prior to the applying the feature vector into a trained machine learning algorithm,
receiving, from an emission filter, training emission spectra corresponding to a training sample comprising a plurality of pure elements of known concentrations;
determining, based on the training emission spectra corresponding to the training sample, a plurality of spectral regions corresponding to the plurality of pure elements of known concentration, wherein each of the plurality of spectral regions is respective to each of the plurality of pure elements of known concentration;
determining, for each of the plurality of spectral regions respective to each of the plurality of pure elements of the known concentrations, one or more features associated with a signature peak of a given spectral region;
forming, for each of the plurality of spectral regions respective to each of the plurality of pure elements of the known concentrations, a feature vector comprising the one or more features associated with the signature peak of the given spectral region;
associating, for each of the plurality of spectral regions respective to each of the plurality of pure elements of the known concentrations, the feature vector with a known concentration of a pure element corresponding to the given spectral region;
training, based on the associated feature vectors, a prediction model to estimate unknown concentrations of a plurality of constituents of a sample.
